(19) United States
(12) Patent Application Publication
(10) Pub. No.: US 2004/0073548 A1
(43) Pub. Date: Apr. 15, 2004

(54) System and method of extracting event sentences from documents

(76) Inventors: Myung-Eun Lim, Taejon (KR); Tae Hyun Kim, Taejon (KR); Bo-Hyun Yun, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/335,888

(22) Filed: Jan. 3, 2003

(30) Foreign Application Priority Data
Oct. 9, 2002 (KR) 2002-61459

(51) Int. Cl. G06F 7/00

(52) U.S. Cl. 707/5

(57) ABSTRACT

Disclosed are a system and method of extracting event sentences from documents. A language processing section 10 performs a morphological analysis and named entity recognition for an input document set. A document-set learning section 20 extracts verb, noun and noun phrase features from the language-processed result, and selects important features and stores them in a database by calculating weights for the respective features. An event sentence extraction section 30 comparatively analyzes the result obtained by language-processing the input document in the language processing section 10 and the result obtained from learning of the document-set learning section 20 to calculate the weights for the respective sentences in the input document and so extract the event sentences depending upon the extracting condition. Therefore, useful data implying the information dependant upon the domain is easily selected and obtained from the document.

### BACKGROUND OF THE INVENTION

1. Field of the Invention

The present invention relates to an information extraction system, and more particularly, to a system and method of extracting event sentences from documents in which the event sentences containing contents of a domain-specified event are extracted by use of a document set related to a specific domain.

2. Background of the Related Art

Generally, an information extraction system utilizes a process of establishing a pattern of domain dependant information, in state that a target domain is restricted for the information extraction, and extracting a specific part of a text by use of the established information. This process may be generally again classified into two processes.

One process is to recognize named entities in the text, and gradually establish a template element, a template relationship, and a scenario template, thereby obtaining the information to be extracted. Meanwhile, the other process is to extract an important part from the text, and compare it with a manually formed pattern, thereby retrieving the wanted information.

In case of the former of extracting the information, however, there is a problem that the information to which the corresponding domain attaches importance has to be retrieved so as to establish the domain information used in each step. In case of the latter of extracting the information, there is also another problem that since the extraction of the important part from the text is relied on the word information the substantial information of the subject is not effectively extracted.

### SUMMARY OF THE INVENTION

Accordingly, the present invention is directed to an information extraction system that substantially obviates one or more problems due to limitations and disadvantages of the related art.

An object of the present invention is to provide a system and method of extracting event sentences from documents. The system automatically learns document set related to the specific subject of the target domain, and extracts the event sentences comprising the information related to the subject, object, date and location of the event which are concrete contents related to the specific subject treated by the specific domain by use of the learned information. Therefore, useful data implying the information dependant upon the domain is easily selected and obtained from the document.

To achieve the object and other advantages, according to one aspect of the present invention, there is provided a system of extracting event sentences from a document, the system comprising: a language processing section for performing a morphological analysis and named entity recognition for an input document or a document set; a document-set learning section for extracting specific features from a result obtained from the language processing section for the learning documents, and for selecting and storing important features in a database; and an event sentence extraction section for extracting event sentences from a processed document by use of the result obtained by language-processing the input document in the language processing section and the result information obtained from the document-set learning section.

According to another aspect of the present invention, there is provided a method and system of extracting event sentences from a document, the method comprising the steps of: designating and inputting a document set related to a specific subject of the target domain; performing a morphological analysis and named entity recognition for the input documents in a language processing section; extracting features of verb and noun from the language-processed results obtained by the language processing section in a document-set learning section, and selecting important features and storing them in a database; and extracting event sentences from a input document by use of the results obtained by the language processing section and a result of learning the document set obtained by the document-set learning section for a specific domain.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view showing a system of extracting event sentences from a document according to the present invention;

FIG. 2 is a flowchart showing a process of extracting event sentences from a document according to the present invention;

FIG. 3 is a flowchart showing a language processing method for a document set;

FIG. 4 is a view showing a language processing result for a specific sentence according to one preferred embodiment of the present invention;

FIG. 5 is a flowchart showing a learning method for a document set;

FIG. 6 is a view showing a method of calculating a weight of a feature in a document-set learning section and a domain information collected for a specific domain;

FIG. 7 is a flowchart showing a method of extracting event sentences from a document set;

FIG. 8 is a view showing a method of calculating a weight of a sentence in an event sentence extracting section and extracting the sentence according to the condition; and

FIG. 9 is a view showing an event sentence extracting result for a specific sentence according to one preferred embodiment of the present invention.

### DETAILED DESCRIPTION OF THE PREFERRED EMBODIMENTS

A preferred embodiment according to the present invention will now be explained with reference to the accompanying drawings.

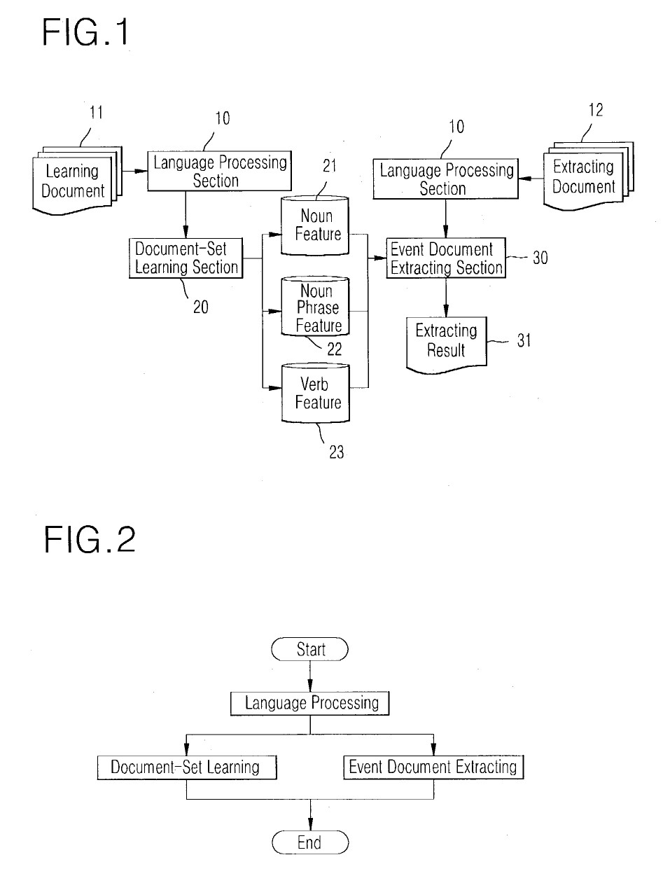

Referring to FIG. 1, a language processing section 10 performs a morphological analysis and named entity recognition for an input learning document set 11 related to a specific subject of the target domain.

A document-set learning section 20 extracts specific features from the results of language-processing the learning documents 11 by the language processing section 10, and selects important features and stores them in a database.

The document-set learning section 20 extracts verb, noun, and noun phrase features from the language-processed document set 11, calculates word occurrence frequencies and document frequencies of the words, collects a list of document's number in which the word is retrieved, selects the features having a higher weight from the results obtained by calculating weights of the respective features, and stores them in databases 21, 22 and 23.

An event sentence extraction section 30 extracts an event sentence 31 from a input document 12 by use of the result obtained by language-processing the input document 12 in the language processing section 10 and the result information obtained from the document-set learning section 20.

The event sentence extraction section 30 collects the information of the verb, noun and noun phrase features contained in the respective sentences from the input document 12, obtains the information of the respective features learned in the document-set learning section 20, calculates weights of the respective features and weights of the sentence by use of the information indicating frequencies of which pairs of different features simultaneously occurs in the specific sentence of the document set 11, and extracts the event sentence 31 according to the conditions given by the weights and the extent contained in the specific features within the sentences.

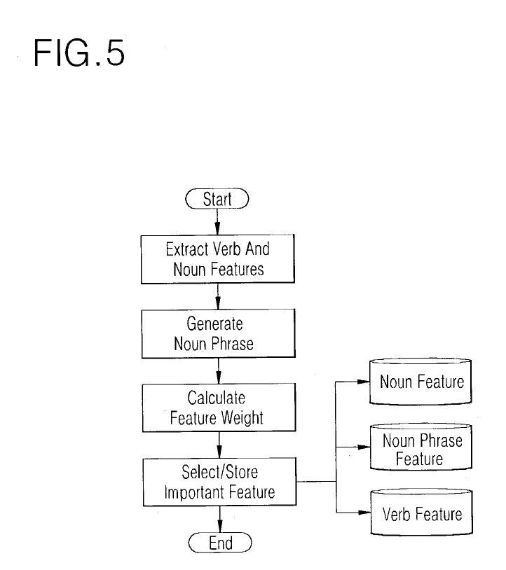

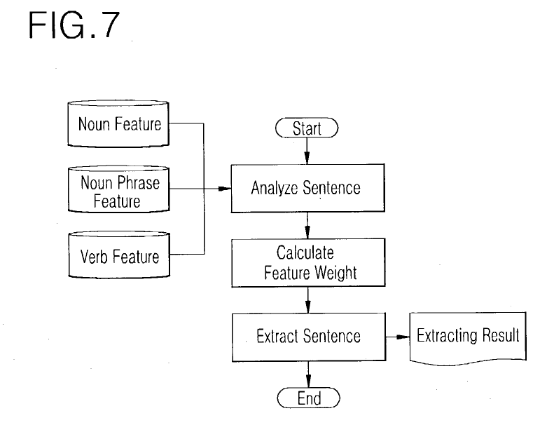

The system of extracting the event sentences from the document according to the present invention is operated as following based on the method shown in FIGS. 2 to 9.

First of all, the document set 11 related to the specific subject of the target domain is designated and inputted in the language processing section 10, the language processing section 10 performs the morphological analysis and the named entity recognition for the input document 11 (step S100).

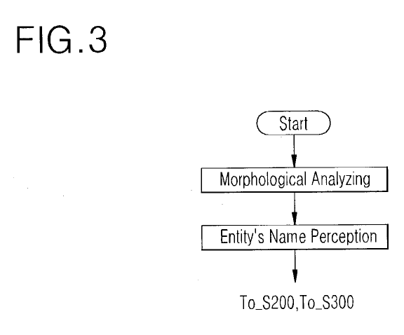

At that time, as shown in FIG. 3, the language processing section 10 performs the morphological analysis (step S101) and the named entity recognition (step S102) for the learning document 11 to be used in the learning step or the input document 12 inputted in the extracting step, and transfers the results to the document-set learning section 20 and the event sentence extraction section 30.

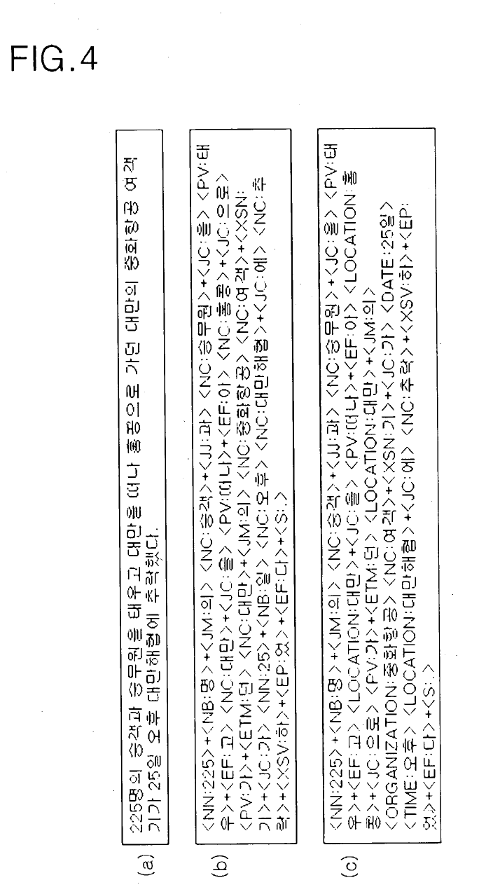

Also, if the language processing section 10 performs the morphological analysis (step S101) for the specific sentence as shown in FIG. 4a, the results of the morphological analysis tagged according to parts-of-speech may be obtained as shown in FIG. 4b. And then, if the language processing section 10 performs the named entity recognition (step S102) based on the above results, the results tagged according to the named entities may be obtained as shown in FIG. 4c.

After the language processing section 10 performs the learning process for the learning document set 11 related to the specific subject, the document-set learning section 20 extracts verb, noun and noun phrase features by use of the results obtained of language-processing the learning documents 11 by the language processing section 10, and selects important features and stores them in the databases 21, 22 and 23, thereby performing the learning on the document set 11 (step S200).

At that time, the document-set learning section 20 extracts verb and noun features from the language-processed results transferred from the language processing section 10 to obtain the static information on the features (step S201), combines a pair of adjacent noun features emerging in the same sentence among the extracted noun features to generate the noun phrase (step S202), calculates the weights of the verb, noun and noun phrase features by use of the static information (step S203), selects the features having the highest weights according to the respective features as the important feature (step S204), and stores them in the databases 21, 22 and 23. The verb features stored in the database 23 serve as a role representative of core actions and circumferences to guide the subject of the domain, while the noun and noun phrase features stored in the databases 21 and 22 serve as a role reflective of the information dependent upon the domain.

The document-set learning section 20 extracts the words tagged in the form of ‘verb (PV)’ and ‘noun+verb (NC+XSV)’ from the language-processed results as the verb features. Verbs auxiliarily used in the sentence to have no a special meaning, such as ‘hada ( [symbol] )’, ‘daeda ( [symbol] )’, ‘dahada ( [symbol] )’ and so forth, have to be excluded.

The document-set learning section 20 extracts the words used in the form of ‘noun’ from the language-processed results as the noun features. At that time, in case of words having a lot of transformations due to its characteristic, the information of part-of-speech is regarded as the noun feature. Otherwise, the word itself is regarded as the noun feature. Specifically, the words having parts-of-speech tag comprising ‘common noun (NC)’, ‘personal noun (PERSON)’, ‘location (LOCATION)’, organization name (ORGANIZATION)’ and so forth are regarded as the noun features. The words having parts-of-speech tag comprising ‘numeral (NN)’, ‘percentage (PERCENT)’, ‘date (DATE)’, ‘time (TIME)’, ‘amount of money (MONEY)’, ‘quantity (QUANTITY)’ and so forth are regarded as the noun features. This is to prevent that the information on the event occurring date and time which are important information in the event, and the amount is omitted from the learning data because of a lower word frequency.

The document-set learning section 20 utilizes combined features of two adjacent noun features emerging in the same sentence as the noun phrase features.

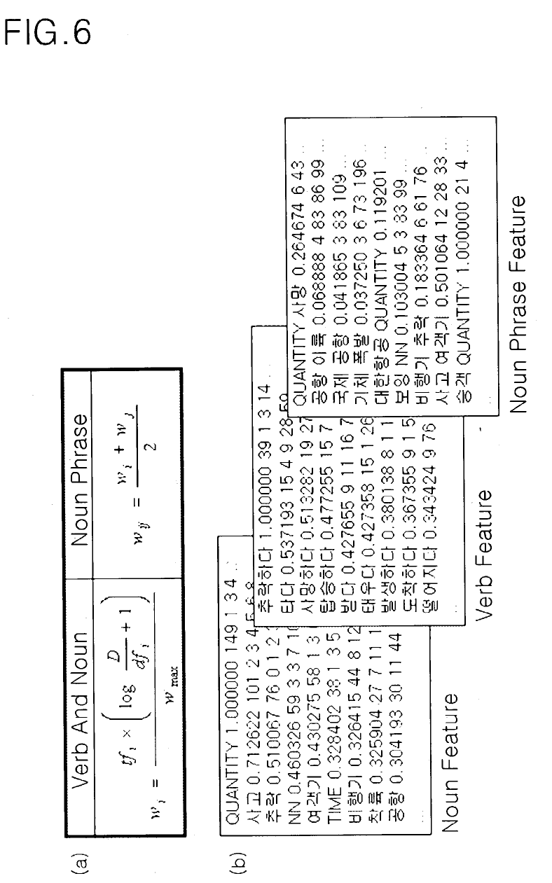

In particular, referring to FIG. 6, the document-set learning section 20 calculates the weights (wᵢ or wⱼ) of the verb and noun features and the weight (wᵢⱼ) of the noun phrase features for the respective features, which are obtained from the process (step S201) of extracting the verb and noun features and the process (step S202) of extracting the noun phrase features, by use of Equations 1 and 2 as shown in FIG. 6a (step S203).

$$\begin{matrix}{W}_{i} = \frac{{tf}_{i} \times ( log \frac{D}{{df}_{i}} + 1 )}{{W}_{max}} & Equation 1 \\ {W}_{ij} = \frac{{W}_{i} + {W}_{j}}{2} & Equation 2\end{matrix}$$

In the above Equations 1 and 2, tf denotes an occurrence frequency of the respective feature, df denotes a document frequency of the respective feature, and D denotes the document number of a document set.

The document-set learning section 20 regards a weighted value, which is standardized by the maximum weighted value every feature, as the weight of the respective features, in case of the verb and noun features, and regards an average value of the weighted values of two noun features of the corresponding noun phrase as the weight of the respective feature, in case of the noun phrase.

Also, the document-set learning section 20 arranges the features in descending order depending upon the weighted values calculated every feature, selects the features having a high order among them and stores them in the database (step S204). For reference, FIG. 6b shows the selected results of the verb, noun, and noun phrase features importantly used in a specific domain of an air accident. By the learning results of the document-set learning section 20, the word of the feature, the weight, the word occurrence frequency, and a list of sentence numbers, for the respective features, may be obtained as shown in FIG. 6b.

After performing the learning for the document set 11, the event sentence extraction section 30 extracts the event sentences from the extracting document 12 by use of the result obtained by language-processing the input document 12 in the language processing section 10 and the result obtained from the learning of the document-set learning section 20 (step S300).

At that time, the event sentence extraction section 30 searches the features contained in the sentences by use of the results by language-processing the input document 12 in the language processing section 10 and the results obtained by learning the domain, combines the domain learning information on the respective features to analyze the sentences (step S301), calculates the weights of the respective sentences by use of the sentence analyzing results (step S302), and extracts the event sentences 31 by use of the degree of the specific features contained in the sentences and the calculated sentence weights (step S303).

The event sentence extraction section 30 extracts the verb and the noun features from the results obtained by language-processing the input document 12 in the sentence analyzing process (step S301), generates the result obtained by combining a pair of adjacent noun features emerging in the same sentence as the noun phrase feature to collect the information on the features contained in the respective sentences, and obtains the lists of the sentences from which the features emerge and the weight of the respective features by use of the results stored in the database by selecting the features having a high weight value of the respective features from the results obtained by calculating the weights on the respective features. Also, the event sentence extraction section 30 collects the information how much the information corresponding to 3W features are contained every sentence with reference to the tag information of the respective language-processed (step S100) sentences, i.e., the information of the 3W features. The 3W feature means the concept of ‘who’, ‘when’ and ‘where’ to discern the information corresponding to the subject, object, date and location of the event.

This is obtained by matching the word having the tag of ‘personal noun (PERSON)’ or ‘organization name (ORGANIZATION)’ with Who feature, matching the word having the tag of ‘data (DATE)’ or ‘time (TIME)’ with When feature, and matching the word ‘location (LOCATION)’ with Where feature, respectively, based on the tag information obtained by the results of the named entity recognition (step S102).

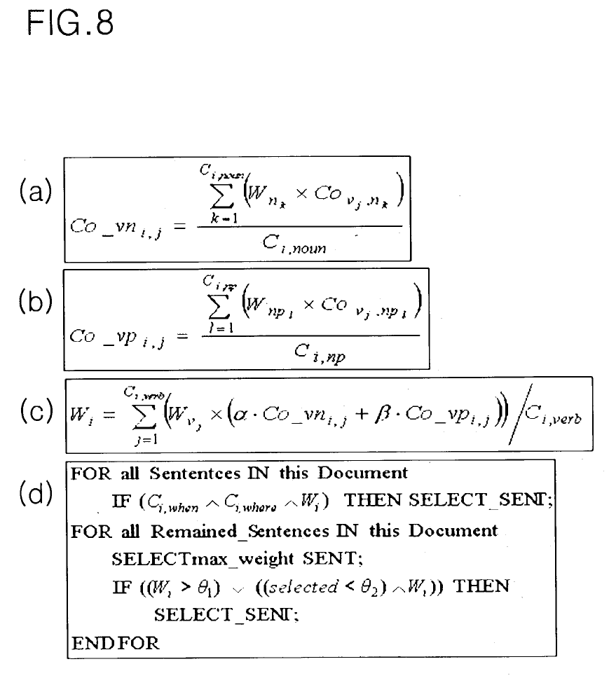

The event sentence extraction section 30 calculates the sentence weight every sentence through the process (step S302) of calculating the sentence weight by use of the following Equation 3 as shown in FIG. 8c, and after the weight of the respective sentence is calculated, arranges the sentences in single document in descending order depending upon the calculated weights.

$${W}_{i} = {\sum }_{j = 1}^{{C}_{j , verb}} ( {W}_{{v}_{j}} \times ( α \cdot {Co\_vn}_{i , j} + β \cdot {Co\_VP}_{i , j} ) ) / {C}_{i , verb} \qquad Equation 3$$

In Equation 3, Co_vn_{i,j} and Co_vp_{i,j} are values to reflect the noun feature and noun phrase feature contained in the sentence in the process (step S302) of calculating the sentence weight, in which Co_vn_{i,j} is calculated by use of the following Equation 4 as shown in FIG. 8a and means an average of sums of the weights for the noun features co-occurring with a verb j at the i^{th} sentence, and Co_vp_{i,j} is calculated by use of the following Equation 5 as shown in FIG. 8b and means an average of sums of the weights for the noun phrase features co-occurring with a verb j at the i^{th} sentence.

$$\begin{matrix}{Co\_vn}_{i , j} = \frac{{\sum }_{k = 1}^{{C}_{i , noun}} ( {W}_{{n}_{k}} \times {Co}_{{v}_{j} , {n}_{k}} )}{{C}_{i , noun}} & Equation 4 \\ {Co\_vp}_{i , j} = \frac{{\sum }_{l = 1}^{{C}_{i , np}} ( {W}_{{np}_{l}} \times {Co}_{{v}_{j} , {np}_{l}} )}{{C}_{i , np}} & Equation 5\end{matrix}$$

In Equations 3 to 5, C_{i,verb,} C_{i,noun} and C_{i,np} denote the number of verb, noun and noun phrase features emerging in each sentence i, respectively, Wᵥ_{ⱼ}, Wₙ_{ₖ} and Wₙₚ_{ₗ} denote the weight of the respective features obtained from the results of learning, Coᵥ_{ⱼ}_{,n}_{ₖ} and Coᵥ_{ⱼ}_{,np}_{ₗ} denote co-occurrence frequencies of verb j and noun phrase 1, and α and β denote a constant adjusted depending upon the extent of which the noun and noun phrase features contribute the sentence extraction.

When calculating the weights of the sentences, the event sentence extraction section 30 utilizes the weighed values of all of the noun, noun phrase and verb features contained in the sentences, and the list of document's numbers from which the features emerge. In the learning document set 11, the list of document's numbers from which the features emerge is utilized to obtain the co-occurrence information between the verb feature and other features, i.e., the verb and the noun, and the verb and the noun phrase. Also, the noun and noun phrase features are utilized to calculate the weights of the sentences for reflecting the information dependent on the domain, and the verb features are utilized to calculate the weights of the sentences for representing the core actions and circumferences guiding the subject of the domain.

After the weights of the respective sentences are calculated as described above, the event sentence extraction section 30 arranges the sentences in single document in descending order depending upon the calculated weights of the sentences, and extracts the event sentences 31 according to the algorithm as shown in FIG. 8d by combining the 3W feature information and the sentence weight information, each obtained in a unit of the sentence through the process of extracting the sentence (step S303).

According to the algorithm as shown in FIG. 8d, the event sentence extraction section 30 extracts the sentences, in which When and Where features are contained and which the weight of the sentence is not zero, from all sentences in the input document 12 as the event sentence in the process (step S303) of extracting the sentence, and selects the sentence having the maximum weight among the remaining sentences which are not extracted from the input document 12, such that if the weight Wᵢ of the sentence is larger than θ₁ or the number of sentences extracted from the document is smaller than θ₂ and the weight Wᵢ of the sentence is larger than zero. For reference, in FIG. 8d θ₁ denotes a critical value of the sentence weight, θ₂ denotes a critical value of the sentence selecting number, and selected denotes the number of event sentences previously selected in the document.

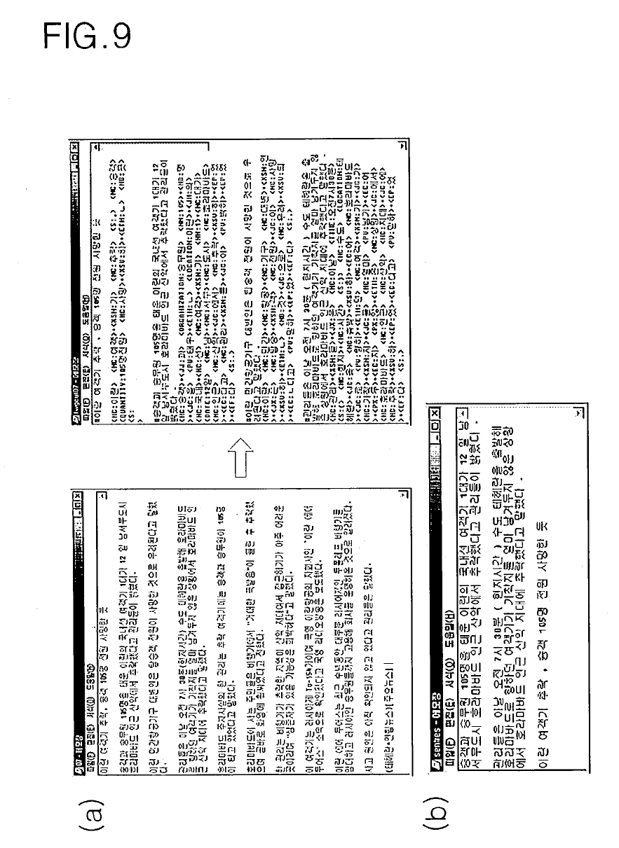

In actual, with the system and method of extracting the event sentences in the document according to the present invention, if the language processing (step S1100) of FIG. 9a which is a specific document related to the domain of air accident is performed, the document learning result (step S200) as shown in FIG. 9b may be obtained. By performing the event document extraction (step S300) using FIG. 9b, the result as shown in FIG. 9c may be obtained.

According to the system and method of extracting the event sentences in the document according to the present invention, the document set related to the specific subject of the target domain is automatically learned, and the event sentences comprising the information related to the subject, object, date and location of the event which are concrete contents related to the specific subject treated by the specific domain are extracted by use of the learned information. Therefore, useful data implying the information dependant upon the domain is easily selected and obtained from the document, so that it may satisfy the demand for a basic level of the information extraction. In particular, since the obtained information may be utilized as the general data for domain information establishment so as to extract the information, there is an advantage that an effort required for the domain information establishment in the information extraction system extracting the information wanted by the user using the information dependant upon the domain may be reduced.

The forgoing embodiments are merely exemplary and are not to be construed as limiting the present invention. The present teachings can be readily applied to other types of systems. The description of the present invention is intended to be illustrative, and not to limit the scope of the claims. Many alternatives, modifications, and variations will be apparent to those skilled in the art.

What is claimed is:

1. A system of extracting event sentences from a document, the system comprising:
a language processing section for performing a morphological analysis and named entity recognition for an input learning document set related to a specific subject of the target domain;
a document-set learning section for extracting specific features from a result obtained from the language processing section for the learning document set, and for selecting important features and storing them in a database; and
an event sentence extraction section for extracting the event sentences from an input document by use of the result obtained by language-processing the input document in the language processing section and the result obtained from learning of the document-set learning section.

2. The system as claimed in claim 1, wherein the document-set learning section extracts verb, noun, and noun phrase features from the language-processed document set, calculates the word occurrence frequencies and the document frequencies of the features, collects a list of document's number in which each feature is retrieved, selects the features having a higher weight from the results calculating weights of the respective features, and stores the result in the database.

3. The system as claimed in claim 1, wherein the event sentence extraction section collects information on verb, noun and noun phrase features contained in the respective sentences from the input document, obtains information of the respective features learned in the document-set learning section, calculates weights of the respective features and weights of the sentences by use of the information indicating the frequencies of which a pair of different features simultaneously occur in the specific sentence of the document set, and extracts the event sentence according to conditions given by the weights and an extent contained in the specific feature within the sentences.

4. A method and system of extracting event sentences from a document, the method comprising the steps of:
designating and inputting a document set related to a specific subject of the target domain;
performing a morphological analysis and named entity recognition for the input documents in a language processing section;
extracting verb and noun features from the language-processed results obtained by the language processing section in a document-set learning section, and selecting important features and storing them in a database; and
extracting event sentences from an input document by use of the language-processed results obtained by the language processing section and a result of learning the document set for a specific domain obtained by the document-set learning section.

5. The method as claimed in claim 4, wherein the document-set learning step includes steps of:
extracting the verb and noun features from the language-processed results for the learning document to obtain static information on the features;
combining a pair of adjacent noun features emerging in the same sentence among the extracted noun features to generate the noun phrase;
calculating the weights of the features for the verb, noun and noun phrase by use of the static information; and
selecting important features from the respective feature sets with weights calculated.

6. The method as claimed in claim 5, wherein in the step of generating the noun phrase by combining the pair of extracted nouns, a pair of adjacent noun features emerging in the same sentence among the extracted noun features are combined to generate the noun phrase

7. The method as claimed in claim 5, wherein in the step of selecting important features from the respective feature sets with the weights calculated and storing the important features in a database, the features having a higher weight are selected from the result of calculating the weights of the respective features obtained from the input document set, and are stored in the database.

8. The method as claimed in claim 4, wherein the event sentence extraction step comprises steps of:
searching the features contained in the sentences by use of the results obtained by language-processing the input document and combining domain learning information on the respective features to analyze the sentences,
calculating the weights of the respective sentences by use of the result provided by the sentence analyzing step; and
extracting the event sentences by use of a degree of the specific features contained in the sentences and the calculated sentence weights.

9. The method as claimed in claim 8, wherein the sentence analyzing step comprises steps of:
extracting the verb features and the noun features from the results obtained by language-processing the input document, and generating the result obtained by combining a pair of adjacent noun features emerging in the same sentence as the noun phrase to collect the information on the feature contained in the respective sentences;
obtaining the lists of the sentences from which the features emerge and the weights of the respective features by use of the results stored in the database by selecting the features having a high weight value of the respective features from the results obtained by calculating the weights on the respective features; and
collecting the information how much the information corresponding to 3W features are contained every sentence.

10. The method as claimed in claim 10, wherein the sentence weight calculating step comprising steps of:
calculating the sentence weights by use of the weights of the noun, noun phrase and verb features collected on the respective sentences and co-occurrence information; and
arranging the sentences in the document in descending order on the basis of the calculated sentence weights.

11. The method as claimed in claim 10, wherein in the sentence extraction step, the event sentences corresponding to condition are extracted by use of the information on the calculated sentence weights and the information on the degree of the 3W features contained in the respective sentences.
